(19) United States
(12) Patent Application Publication
(10) Pub. No.: US 2026/0129735 A1
(43) Pub. Date: May 7, 2026

(54) LIGHTING CONTROL SYSTEM AND METHOD FOR AMUSEMENT DEVICE

(71) Applicant: GuangZhou DreamFuns Amusement Technology Co., Ltd, Guangzhou City (CN)

(72) Inventors: Yongfeng LU, Guangzhou City (CN); Sijin CHEN, Guangzhou City (CN)

(73) Assignee: GuangZhou DreamFuns Amusement Technology Co., Ltd, Guangzhou City (CN)

(21) Appl. No.: 19/001,260

(22) Filed: Dec. 24, 2024

(30) Foreign Application Priority Data
Nov. 7, 2024 (CN) 2024115859806

(51) Int. Cl. H05B 47/165; H05B 47/11; H05B 47/17; H05B 47/175; H05B 47/19

(52) U.S. Cl. CPC H05B 47/165; H05B 47/11; H05B 47/17; H05B 47/19; H05B 47/1965

(57) ABSTRACT

The present disclosure provides a lighting control system and a method for amusement device, relating to the technical field of smart homes. The lighting control system for amusement device includes a cloud server, an Internet of Things module of the amusement device, and a user terminal. The Internet of Things module includes a smart lighting device and a gateway device which are paired to connect, wherein the gateway device and the user terminal are both communicatively connected to the cloud server.

### CROSS-REFERENCES TO RELATED APPLICATIONS

The present disclosure claims priority to Chinese Patent Application No. 2024115859806, entitled “LIGHTING CONTROL SYSTEM AND METHOD FOR AMUSEMENT DEVICE” filed on Nov. 7, 2024 with the China Patent Office, the entire contents of which are incorporated herein by reference.

### TECHNICAL FIELD

The present disclosure relates to the technical field of smart homes, and specifically, to a lighting control system and a method for amusement device.

### BACKGROUND ART

With the development of Internet of Things (IoT) technology, applications in fields such as smart homes and smart buildings are becoming increasingly widespread. Lighting control is one of the important application scenarios, and the traditional lighting control systems for amusement device typically rely on local hardware devices and preset programs, which lack flexibility and intelligence. This leads to poor player experience.

### SUMMARY

The objective of the present disclosure is to provide a lighting control system and a method for amusement device to achieve efficient, flexible, and intelligent lighting control, thereby improving the player experience of amusement device.

In a first aspect, the present disclosure provides a lighting control system for amusement device, including a cloud server, an Internet of Things module of the amusement device, and a user terminal. The Internet of Things module includes a smart lighting device and a gateway device which are paired to connect, wherein the gateway device and the user terminal are both communicatively connected to the cloud server.

The user terminal is configured to send lighting control commands to the cloud server. The cloud server is configured to receive the lighting control commands and issue a corresponding first lighting adjustment strategy to the gateway device. The smart lighting device is configured to acquire the first lighting adjustment strategy forwarded by the gateway device and perform lighting adjustment of the amusement device based on the first lighting adjustment strategy.

The gateway device is further configured to upload real-time environment data of the amusement device to the cloud server. The cloud server is further configured to receive the real-time environment data, generate a second lighting adjustment strategy matching user habits according to the real-time environment data and a trained lighting adjustment model, and send the second lighting adjustment strategy to the gateway device, wherein the lighting adjustment model is trained based on historical environment data and historical user usage data, and the historical user usage data includes offline adjustment data of the smart lighting device uploaded by the gateway device and remote adjustment data corresponding to historical lighting control commands sent by the user terminal; and the smart lighting device is further configured to acquire the second lighting adjustment strategy forwarded by the gateway device and perform lighting adjustment of the amusement device based on the second lighting adjustment strategy.

Further, the cloud server is also configured to perform data preprocessing and feature extraction on the real-time environment data to obtain current time features and current environment features, input the current time features and the current environment features into the lighting adjustment model to obtain a predicted lighting adjustment strategy output by the lighting adjustment model, and determine the second lighting adjustment strategy based on the predicted lighting adjustment strategy. The data preprocessing includes data cleaning and data standardization. The lighting adjustment model uses supervised learning algorithms to predict user-preferred lighting settings, unsupervised learning algorithms to identify user usage patterns, and time series analysis to predict user usage times.

Further, the cloud server is further configured to optimize the lighting usage time and the lighting brightness in the predicted lighting adjustment strategy based on preset energy consumption setting parameters to obtain the second lighting adjustment strategy.

Further, the cloud server is further configured to periodically collect historical environment data and historical user usage data and update the lighting adjustment model based on the historical environment data and historical user usage data. The historical user usage data includes one or more of switch-on/off times, lighting brightness adjustment records, lighting color adjustment records, scene mode selection records, and user manual adjustment frequencies.

Further, the lighting control commands include one or more of lighting scene information, lighting brightness information, and lighting color information, wherein the lighting scene information includes a reading mode, a leisure mode, or a sleep mode.

Further, the user terminal is further configured to send device management commands to the cloud server. The cloud server is configured to receive the device management commands and perform target management of the smart lighting device based on the device management commands. The target management includes one or more of device registration, status monitoring, and fault diagnosis.

Further, the smart lighting device interacts data with the gateway device through a preset communication protocol, and the gateway device is communicatively connected to the cloud server via Wi-Fi or a wired network. The communication protocol includes Wi-Fi or Bluetooth.

In a second aspect, the present disclosure further provides a lighting control method for amusement device, applicable to the lighting control system for amusement device in the first aspect. The lighting control method for amusement device includes:
the user terminal sending lighting control commands to the cloud server;
the cloud server receiving the lighting control commands and issuing a corresponding first lighting adjustment strategy to the gateway device;
the smart lighting device acquiring the first lighting adjustment strategy forwarded by the gateway device and performing lighting adjustment of the amusement device based on the first lighting adjustment strategy;
the gateway device uploading the real-time environment data of the amusement device to the cloud server;
the cloud server receiving the real-time environment data, generating a second lighting adjustment strategy matching user habits according to the real-time environment data and a trained lighting adjustment model, and sending the second lighting adjustment strategy to the gateway device, wherein the lighting adjustment model is trained based on historical environment data and historical user usage data, and the historical user usage data includes offline adjustment data of the smart lighting device uploaded by the gateway device and the remote adjustment data corresponding to historical lighting control commands sent by the user terminal; and
the smart lighting device acquiring the second lighting adjustment strategy forwarded by the gateway device and performing lighting adjustment of the amusement device based on the second lighting adjustment strategy.

Further, the step of generating a second lighting adjustment strategy matching user habits according to the real-time environment data and a trained lighting adjustment model includes:
performing a data preprocessing and a feature extraction on the real-time environment data to obtain current time features and current environment features, wherein the data preprocessing includes data cleaning and data standardization;
inputting the current time features and the current environment features into the lighting adjustment model to obtain a predicted lighting adjustment strategy output by the lighting adjustment model, wherein the lighting adjustment model uses supervised learning algorithms to predict user-preferred lighting settings, unsupervised learning algorithms to identify user usage patterns, and time series analysis to predict user usage times; and
determining the second lighting adjustment strategy based on the predicted lighting adjustment strategy.

Further, the step of determining the second lighting adjustment strategy based on the predicted lighting adjustment strategy includes:
optimizing the lighting usage time and the lighting brightness in the predicted lighting adjustment strategy based on preset energy consumption setting parameters to obtain the second lighting adjustment strategy.

In the lighting control system and the method of amusement device provided in the present disclosure, the lighting control system for amusement device includes the cloud server, the Internet of Things module of the amusement device, and the user terminal. The Internet of Things module includes the smart lighting device and the gateway device which are paired to connect, wherein the gateway device and the user terminal are both communicatively connected to the cloud server. The user terminal is configured to send lighting control commands to the cloud server. The cloud server is configured to receive the lighting control commands and issue the corresponding first lighting adjustment strategy to the gateway device. The smart lighting device is configured to acquire the first lighting adjustment strategy forwarded by the gateway device and perform the lighting adjustment of the amusement device based on the first lighting adjustment strategy. The gateway device is further configured to upload the real-time environment data of the amusement device to the cloud server. The cloud server is further configured to receive the real-time environment data, generate the second lighting adjustment strategy matching user habits according to the real-time environment data and the trained lighting adjustment model, and send the second lighting adjustment strategy to the gateway device. The lighting adjustment model is trained based on historical environment data and historical user usage data, and the historical user usage data includes the offline adjustment data of the smart lighting device uploaded by the gateway device and the remote adjustment data corresponding to historical lighting control commands sent by the user terminal. The smart lighting device is further configured to acquire the second lighting adjustment strategy forwarded by the gateway device and perform the lighting adjustment of the amusement device based on the second lighting adjustment strategy.

Through the integration of the cloud technology and Internet of Things hardware, the lighting control system for amusement device can achieve both remote and localized control of the smart lighting devices. It also enables intelligent interaction with the senses of the player, thus providing intelligent lighting adjustment experiences that match user habits, and achieving personalized lighting adjustments. Users can adjust the lighting settings of amusement device anytime and anywhere according to their actual needs, thus enhancing the convenience and flexibility of using the amusement device. Therefore, the lighting control system and method for amusement device provided by the present disclosure achieve efficient, flexible, and intelligent lighting control, thereby improving the player experience of amusement device.

### BRIEF DESCRIPTION OF DRAWINGS

In order to more clearly illustrate technical solutions in the specific embodiments of the present disclosure or in the prior art, the drawings required to be used in the description of the specific embodiment or prior art will be briefly introduced as follows. Obviously, the drawings described below are some embodiments of the present disclosure, for those of ordinary skill in the art, without paying inventive efforts, may also obtain other drawings according to these drawings.

FIG. 1 is a schematic structural diagram of a lighting control system for amusement device provided by the embodiment of the present disclosure;

FIG. 2 is a schematic system architecture diagram of a lighting control system for amusement device provided by the embodiment of the present disclosure;

FIG. 3 is a schematic flow diagram of a lighting control method for amusement device provided by the embodiment of the present disclosure; and

FIG. 4 is a schematic flow diagram of another lighting control method for amusement device provided by the embodiment of the present disclosure.

Reference numerals: 110—cloud server; 120—Internet of Things module; 121—gateway device; 122—smart lighting device; and 130—user terminal.

### DETAILED DESCRIPTION OF EMBODIMENTS

The technical solutions of the present disclosure will be clearly and completely described below in connection with the embodiments. Obviously, the described embodiments are a part of the embodiments of the present disclosure and not all of the embodiments. Based on the embodiments of the present disclosure, all other embodiments obtained by those of ordinary skill in the art without making inventive efforts are within the scope of protection of the present disclosure.

The existing lighting control systems have deficiencies in aspects such as remote control, energy management, and system integration. For example, current lighting control systems cannot achieve intelligent interaction with the senses of the players in amusement device and fail to provide personalized lighting adjustment solutions, leading to poor player experiences. In view of this, the embodiments of the present disclosure provide a lighting control system and a method for amusement device. By adopting the cloud technology and Internet of Things hardware, data processing and device management are performed via the cloud server, thus enabling more efficient, flexible, and intelligent lighting control. This, to a certain extent, addresses certain issues in the prior art, including insufficient intelligence, inconvenience in remote control, and incomplete energy management.

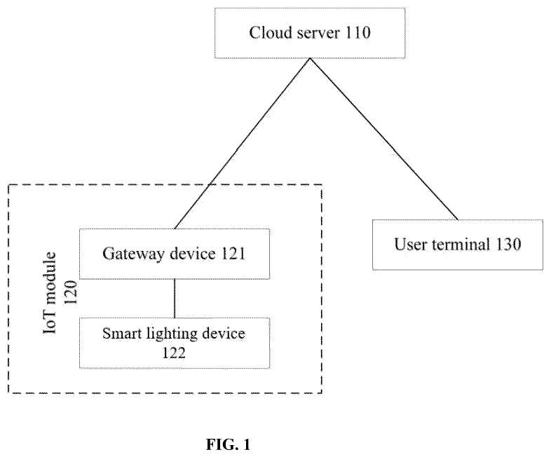

A lighting control system for amusement device is provided in the embodiments of the present disclosure. As shown in FIG. 1, the lighting control system for amusement device includes a cloud server 110, an Internet of Things module 120 of the amusement device, and a user terminal 130. The Internet of Things module 120 includes a smart lighting device 122 and a gateway device 121 which are paired to connect, wherein the gateway device 121 and the user terminal 130 are both communicatively connected to the cloud server 110. The cloud server 110 is primarily configured for data processing and issuing commands. The Internet of Things module 120 is primarily configured for receiving and executing control commands. The user terminal 130 is primarily configured for sending the control commands and receiving device status information.

The lighting control system for amusement device can provide remote control functionalities for amusement device as follows. The user terminal 130 is configured to send lighting control commands to the cloud server 110. The cloud server 110 is configured to receive the lighting control commands and issue a corresponding first lighting adjustment strategy to the gateway device 121. The smart lighting device 122 is configured to acquire the first lighting adjustment strategy forwarded by the gateway device 121 and perform lighting adjustment of the amusement device based on the first lighting adjustment strategy.

The cloud server 110 can convert the lighting control commands from the user terminal 130 into the corresponding first lighting adjustment strategy, thereby controlling the lighting adjustments of the smart lighting device 122. Optionally, the lighting control commands can include one or more of lighting scene information, lighting brightness information, and lighting color information, wherein the lighting scene information can include a reading mode, a leisure mode, or a sleep mode. This enables users to remotely control lighting scenes, lighting brightness, and lighting colors of the amusement device.

The lighting control system for amusement device can further provide intelligent lighting adjustment experiences as follows. The gateway device 121 is further configured to upload real-time environment data of the amusement device to the cloud server 110. The cloud server 110 is further configured to receive the real-time environment data, generate a second lighting adjustment strategy matching user habits according to the real-time environment data and a trained lighting adjustment model, and send the second lighting adjustment strategy to the gateway device 121. The lighting adjustment model is trained based on historical environment data and historical user usage data, and the historical user usage data includes offline adjustment data of the smart lighting device uploaded by the gateway device 121 and remote adjustment data corresponding to historical lighting control commands sent by the user terminal 130. The smart lighting device 122 is further configured to acquire the second lighting adjustment strategy forwarded by the gateway device 121 and perform lighting adjustment of the amusement device based on the second lighting adjustment strategy.

The cloud server 110 can acquire historical environment data and historical user usage data and analyze user habits through machine learning algorithms to generate a lighting adjustment model. By using the lighting adjustment model in combination with the real-time environment data, it can automatically generate lighting control strategies. For example, it can automatically activate soft warm-colored lighting at dusk or dim the lighting when the ambient light is low. The environmental data (historical environment data/real-time environment data) can include one or more of the light intensity, temperature, humidity, and air pressure. The historical user usage data can include one or more of switch-on/off times, lighting brightness adjustment records, lighting color adjustment records, scene mode selection records, and user manual adjustment frequencies. The aforementioned offline adjustment data refers to adjustment data corresponding to the settings or adjustments of the smart lighting device performed directly by the user on the amusement device. When training the lighting adjustment model, cross-validation can be used to evaluate model performance, and hyperparameter tuning can optimize the model.

Through the integration of cloud technology and Internet of Things hardware, the lighting control system for amusement device can achieve both remote and localized control of smart lighting devices. It also enables intelligent interaction with the senses of the player, thus providing intelligent lighting adjustment experiences that match user habits, and achieving personalized lighting adjustments. Users can adjust the lighting settings of amusement device anytime and anywhere according to their actual needs, thus enhancing the convenience and flexibility of using the amusement device. Therefore, the lighting control system for amusement device provided achieves efficient, flexible, and intelligent lighting control, thereby improving the player experience of amusement device.

Optionally, the aforementioned user terminal 130 can include a smartphone, tablet, or other mobile devices.

Optionally, the aforementioned smart lighting device 122 can interact data with the gateway device 121 through a preset communication protocol, and the gateway device 121 can be communicatively connected to the cloud server 110 via Wi-Fi or a wired network. The communication protocol includes Wi-Fi, Bluetooth, and so on. The gateway device 121 can communicate with the cloud server 110 and the user terminal 130 using Wi-Fi or Bluetooth communication protocols.

In some possible embodiments, the aforementioned cloud server 110 is also configured to perform data preprocessing and feature extraction on the real-time environment data to obtain current time features and current environment features, input the current time features and the current environment features into the lighting adjustment model to obtain a predicted lighting adjustment strategy output by the lighting adjustment model, and determine the second lighting adjustment strategy based on the predicted lighting adjustment strategy. The data preprocessing includes data cleaning and data standardization. The lighting adjustment model uses supervised learning algorithms to predict user-preferred lighting settings, unsupervised learning algorithms to identify user usage patterns, and time series analysis to predict user usage times.

Specifically, the data cleaning is used to remove outliers and noise, the data standardization is used to unify data of different dimensions to the same scale. During feature extraction, time features such as the hour, day of the week, and month can be extracted from timestamps. Composite features combining the light intensity, temperature, humidity, and air pressure can serve as environmental features. Supervised learning algorithms can include random forests or gradient boosting trees. Unsupervised learning algorithms can employ K-means clustering. Time series analysis can use ARIMA (autoregressive integrated moving average) models and so on. By integrating supervised learning algorithms, unsupervised learning algorithms, and time series analysis, accurate predictions for lighting adjustment strategies can be achieved.

In one possible embodiment, the predicted lighting adjustment strategy can be directly used as the second lighting adjustment strategy.

In another possible embodiment, the predicted lighting adjustment strategy can be optimized based on the energy consumption requirements of users to obtain the second lighting adjustment strategy. Based on this, the aforementioned lighting control system for amusement device also provides energy consumption management capabilities as follows. The cloud server 110 is further configured to optimize the lighting usage time and the lighting brightness in the predicted lighting adjustment strategy based on preset energy consumption setting parameters to obtain the second lighting adjustment strategy. The energy consumption parameters are user-defined parameters. For example, the users can choose to enable or disable an energy-saving mode to generate the corresponding energy consumption setting parameters. By optimizing lighting usage time and lighting brightness, energy consumption can be reduced, thus achieving energy-saving effects.

Optionally, the aforementioned cloud server 110 is further configured to periodically collect historical environment data and historical user usage data and update the lighting adjustment model based on the historical environment data and historical user usage data. The historical user usage data includes one or more of switch-on/off times, lighting brightness adjustment records, lighting color adjustment records, scene mode selection records, and user manual adjustment frequencies. By regularly updating the lighting adjustment model, changes in user preferences for amusement device lighting can be promptly identified, further enhancing the player experience of the amusement device.

Optionally, the aforementioned user terminal 130 is further configured to send device management commands to the cloud server 110. The cloud server 110 is configured to receive the device management commands and perform a target management of the smart lighting device based on the device management commands. The target management includes one or more of device registration, status monitoring, and fault diagnosis. The cloud server 110 can manage the amusement device based on user operations, including device registration, status monitoring, and fault diagnosis. The user terminal 130 can obtain device status information from the cloud server 110, such as device registration information, status monitoring information, and fault diagnosis information.

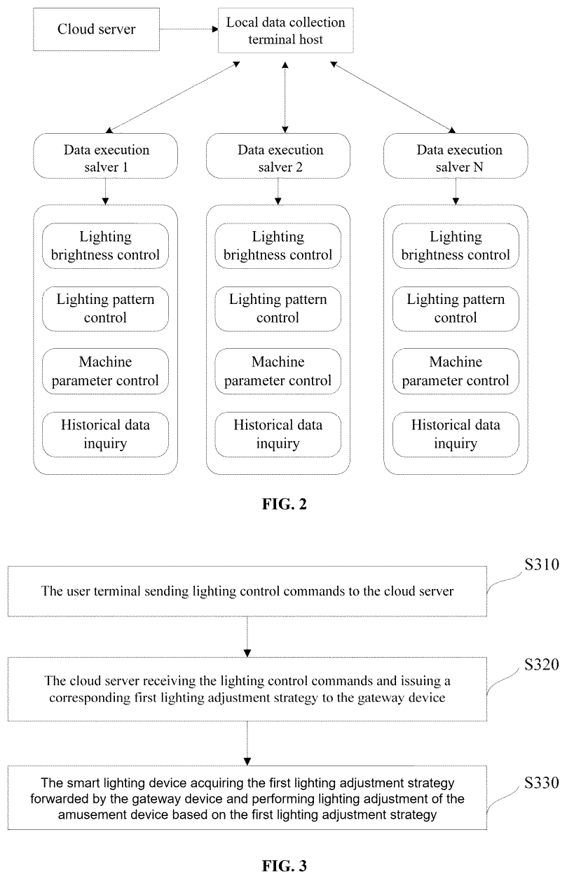

In one possible embodiment, as shown in FIG. 2, the gateway device 121 can be a local data collection terminal host. The local data collection terminal host can aggregate environmental data collected by various environmental sensors and upload it to the cloud server 110. The environmental sensors can include ambient light sensors, temperature and humidity sensors, and barometric pressure sensors. The aforementioned smart lighting device 122 can include multiple data execution slavers, such as data execution slaver 1 and data execution slaver 2. The lighting adjustment strategies issued by the cloud server 110 can include sub-strategies corresponding to each data execution slaver. The local data collection host can acquire the lighting adjustment strategies issued by the cloud server 110 and issue each sub-strategy to the corresponding data execution slavers, thus enabling an intelligent lighting adjustment experience. Each data execution slaver can achieve functionalities such as lighting brightness control, lighting pattern control, machine parameter control, and historical data inquiry. The cloud server 110 can issue lighting adjustment strategies to control the lighting brightness of each data execution slaver, thereby achieving energy management.

For ease of understanding, the above lighting control system for amusement device is described in detail below.

The aforementioned lighting control system for amusement device primarily includes the following components:

### 1. Cloud Server

(1) responsible for data storage, processing, and analysis, and issuing user control commands;
(2) the cloud server communicating with user control terminals (i.e., user terminals such as smartphones, and tablets) through open API interfaces; and
(3) the cloud server employing big data analytics to recommend intelligent lighting adjustment strategies based on user habits and environmental data;

### 2. Internet of Things Hardware Module (Internet of Things Module)

(1) including a smart lighting device and a gateway device connecting to the cloud server;
(2) the smart lighting device interacting data with the gateway device using communication protocols such as Wi-Fi or Bluetooth; and
(3) the gateway device being responsible for receiving control commands from the cloud server and forwarding them to the corresponding smart lighting devices; and

### 3. User Terminal Control Module

(1) users remotely controlling the smart lighting device in amusement device via an application (APP) installed on smartphones or other mobile devices; and
(2) the APP communicating with the cloud server and forwarding user control commands to the Internet of Things hardware module through the cloud server to achieve the lighting control.

The implementation of the above-described functionalities of the lighting control system for amusement device can include the following steps.

### Step 1: System Initialization.

Users download and install the APP on the user terminal; register an account and log in; and bind the gateway device to the user account by scanning the QR code of the gateway device through the APP or entering the device identification code.

### Step 2: Connection of the Smart Lighting Device to the Gateway Device.

Following APP instructions, users pair the smart lighting device with the gateway device, and the smart lighting device establishes a communication connection with the gateway device through specified communication protocols.

### Step 3: Cloud Configuration and Management.

The gateway device connects to the Internet via Wi-Fi or wired networks and establishes stable communication with the cloud server; and the cloud server manages the amusement device based on user operations, including registration, status monitoring, and fault diagnosis of the amusement device.

### Step 4: Lighting Control and Management.

Users selects lighting scenarios (e.g., reading mode, leisure mode, or sleeping mode) or customizes the lighting brightness and color settings through the APP interface. The APP sends user control commands to the cloud server; the cloud server performs the corresponding logical processing on the commands and sends them to the corresponding gateway device; and the gateway device forwards the commands to the smart lighting device for execution.

### Step 5: Intelligent Adjustment.

The cloud server periodically collects user usage data and environmental sensor data (e.g., light intensity, temperature, humidity, and time information); and uses machine learning algorithms to analyze user habits to automatically adjust lighting control strategies, for example, it can automatically activate soft warm-colored lighting at dusk or dim the lighting of the amusement device when the ambient light is low.

Through the above solution, the lighting control system for amusement device can realize remote and localized control of smart lighting devices, thus providing a more intelligent lighting adjustment experience. Users can adjust the lighting settings anytime and anywhere according to actual needs, thus enhancing the convenience and flexibility of use. Meanwhile, the cloud server can perform big data analysis to provide personalized lighting control strategies, thus enhancing the user experience. In addition, the lighting control system for the amusement device also provides energy consumption management functions, reducing energy consumption by optimizing lighting usage time and brightness.

In summary, the lighting control system for the amusement device provided by the embodiments of the present disclosure, through the combination of cloud technology and Internet of Things hardware, achieves intelligent control of lighting for amusement device. This not only improves the user experience but also provides efficient energy consumption management, with broad application prospects and market value.

The embodiments of the present disclosure further provide a lighting control method for the amusement device, wherein the lighting control method for the amusement device is applied to the above lighting control system for the amusement device. The lighting control method for amusement device can realize the function of remote control for amusement device. Referring to FIG. 3, which is a schematic flow diagram of a lighting control method for amusement device, the lighting control method for amusement device includes the following steps.

Step S310: the user terminal sending lighting control commands to the cloud server.

Step S320: the cloud server receiving the lighting control commands and issuing a corresponding first lighting adjustment strategy to the gateway device.

Step S330: the smart lighting device acquiring the first lighting adjustment strategy forwarded by the gateway device and performing lighting adjustment of the amusement device based on the first lighting adjustment strategy.

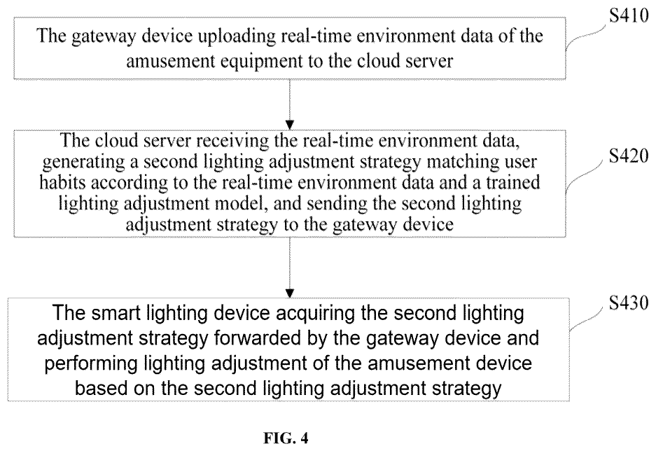

The above lighting control method for amusement device can further provide intelligent lighting adjustment experiences. Referring to FIG. 4, which is a schematic flow diagram of another lighting control method for amusement device, the lighting control method for amusement device includes the following steps.

Step S410: the gateway device uploading real-time environment data of the amusement device to the cloud server.

Step S420: the cloud server receiving the real-time environment data, generating a second lighting adjustment strategy matching user habits according to the real-time environment data and a trained lighting adjustment model, and sending the second lighting adjustment strategy to the gateway device.

The lighting adjustment model is trained based on historical environment data and historical user usage data, and the historical user usage data includes offline adjustment data of the smart lighting device uploaded by the gateway device and remote adjustment data corresponding to historical lighting control commands sent by the user terminal.

In some possible embodiments, the step S420 can include: performing a data preprocessing and a feature extraction on the real-time environment data to obtain current time features and current environment features, wherein the data preprocessing includes data cleaning and data standardization; inputting the current time features and the current environment features into the lighting adjustment model to obtain a predicted lighting adjustment strategy output by the lighting adjustment model, wherein the lighting adjustment model uses supervised learning algorithms to predict user-preferred lighting settings, unsupervised learning algorithms to identify user usage patterns, and time series analysis to predict user usage times; and determining the second lighting adjustment strategy based on the predicted lighting adjustment strategy.

In one possible embodiment, the predicted lighting adjustment strategy can be optimized based on the energy consumption requirements of users to obtain the second lighting adjustment strategy. Thereby, the lighting usage time and the lighting brightness in the predicted lighting adjustment strategy can be optimized based on preset energy consumption setting parameters to obtain the second lighting adjustment strategy.

Step S430: the smart lighting device acquiring the second lighting adjustment strategy forwarded by the gateway device and performing lighting adjustment of the amusement device based on the second lighting adjustment strategy.

Through the integration of cloud technology and Internet of Things hardware, the lighting control method for amusement device can achieve both remote and localized control of smart lighting devices. It also enables intelligent interaction with the senses of the player, thus providing intelligent lighting adjustment experiences that match user habits, and achieving personalized lighting adjustments. Users can adjust the lighting settings of amusement device anytime and anywhere according to their actual needs, thus enhancing the convenience and flexibility of using the amusement device. Therefore, the lighting control method for amusement device achieves efficient, flexible, and intelligent lighting control, thereby improving the player experience of amusement device.

The principles and technical effects of the lighting control method for amusement device provided in the embodiments of the present disclosure are similar to foregoing embodiments described for the lighting control system for amusement device. For brief description, if any part of the embodiments of the lighting control method for amusement device is not explicitly mentioned, the corresponding content in the embodiments of the lighting control system for amusement device can be referred to.

In the present disclosure, the term “and/or” is used as a way to describe the relationship between associated objects, indicating that there can be three possible relationships. For example, “A and/or B” can represent: the presence of A, the presence of both A and B, or the presence of B. In addition, the term “at least one” as used herein refers to any one of a plurality or any combination of at least two of the plurality, for example, “including at least one of A, B, and C” may indicate any one or more elements selected from the set consisting of A, B, and C.

In all examples shown and described herein any specific value should be construed as illustrative only and not as a limitation. Thus, other examples of exemplary embodiments may have different values.

It should be noted that similar numerals and letters denote similar terms in the following drawings, so that once an item is defined in one drawing, it does not need to be further discussed in subsequent drawings.

Additionally, in the description of the embodiment of the present disclosure, unless otherwise clearly stipulated and limited, the terms “mount”, “connect”, and “link” should be understood in a broad sense. For example, it can be a fixed connection, a detachable connection, or an integral connection; it can be a mechanical connection or an electrical connection; and it can be a direct connection, an indirect connection through an intermediary, or an internal communication between two components. Those of ordinary skill in the art can understand the meanings of the above terms in the present disclosure according to specific situations.

In the description of the present disclosure, it should be noted that the terms “center”, “top”, “bottom”, “left”, “right”, “vertical”, “horizontal”, “inner”, “outer” “right”, ‘vertical’, ‘horizontal’, ‘inside’, ‘outside’, and the like indicating orientation or positional relationships are based on the orientation or positional relationships shown in the drawings. These terms are merely intended to facilitate the description of the present disclosure and simplify the description and are not intended to indicate or imply that the referenced devices or elements must have a specific orientation, be constructed in a specific orientation, or operate in a specific orientation. Therefore, these terms should not be construed as limiting the present disclosure. In addition, the terms “first”, “second” and “third” are used for descriptive purposes only and are not to be construed as indicating or implying relative importance.

Finally, it should be noted that the above embodiments are only used to illustrate the technical solution of the present disclosure, not to limit it; While the present disclosure has been described in detail with reference to the preceding embodiments, it will be understood by those of ordinary skill in the art that, one may still modify the technical solution described in the preceding embodiments, or replace some or all of the technical features equally. These modifications or substitutions do not depart the essence of the corresponding technical solution from the scope of the technical solution of the embodiments of the present disclosure.

1. A lighting control system for amusement device, comprising a cloud server, an Internet of Things module of the amusement device, and a user terminal, wherein the Internet of Things module comprises a smart lighting device and a gateway device which are paired to connect, and the gateway device and the user terminal are both communicatively connected to the cloud server;
the user terminal is configured to send lighting control commands to the cloud server; the cloud server is configured to receive the lighting control commands and issue a corresponding first lighting adjustment strategy to the gateway device; the smart lighting device is configured to acquire the first lighting adjustment strategy forwarded by the gateway device and perform a lighting adjustment of the amusement device based on the first lighting adjustment strategy; and
the gateway device is further configured to upload real-time environment data of the amusement device to the cloud server; the cloud server is further configured to receive the real-time environment data, generate a second lighting adjustment strategy matching user habits according to the real-time environment data and a trained lighting adjustment model, and send the second lighting adjustment strategy to the gateway device, wherein the lighting adjustment model is trained based on historical environment data and historical user usage data, and the historical user usage data comprises offline adjustment data of the smart lighting device uploaded by the gateway device and remote adjustment data corresponding to historical lighting control commands sent by the user terminal; and
the smart lighting device is further configured to acquire the second lighting adjustment strategy forwarded by the gateway device and perform lighting adjustment of the amusement device based on the second lighting adjustment strategy.

2. The lighting control system for the amusement device according to claim 1, wherein the cloud server is further configured to perform a data preprocessing and a feature extraction on the real-time environment data to obtain current time features and current environment features; input the current time features and the current environment features into the lighting adjustment model to obtain a predicted lighting adjustment strategy output by the lighting adjustment model; and determine the second lighting adjustment strategy based on the predicted lighting adjustment strategy, wherein the data preprocessing comprises data cleaning and data standardization; and the lighting adjustment model uses supervised learning algorithms to predict user-preferred lighting settings, unsupervised learning algorithms to identify user usage patterns, and time series analysis to predict user usage times.

3. The lighting control system for the amusement device according to claim 2, wherein the cloud server is further configured to optimize a lighting usage time and a lighting brightness in the predicted lighting adjustment strategy based on preset energy consumption setting parameters to obtain the second lighting adjustment strategy.

4. The lighting control system for the amusement device according to claim 1, wherein the cloud server is further configured to periodically collect the historical environment data and the historical user usage data and update the lighting adjustment model based on the historical environment data and the historical user usage data, wherein the historical user usage data comprises one or more of switch-on/off times, lighting brightness adjustment records, lighting color adjustment records, scene mode selection records, and user manual adjustment frequencies.

5. The lighting control system for the amusement device according to claim 1, wherein the lighting control commands comprise one or more of lighting scene information, lighting brightness information, and lighting color information, wherein the lighting scene information comprises a reading mode, a leisure mode, or a sleep mode.

6. The lighting control system for the amusement device according to claim 1, wherein the user terminal is further configured to send device management commands to the cloud server; the cloud server is further configured to receive the device management commands and perform a target management of the smart lighting device based on the device management commands; and the target management comprises one or more of device registration, status monitoring, and fault diagnosis.

7. The lighting control system for the amusement device according to claim 1, wherein the smart lighting device interacts data with the gateway device through a preset communication protocol, and the gateway device is communicatively connected to the cloud server via Wi-Fi or a wired network; and the communication protocol comprises Wi-Fi or Bluetooth.

8. A lighting control method for amusement device, applicable to the lighting control
system for the amusement device according to claim 1, wherein the lighting control method for amusement device comprises:
the user terminal sending the lighting control commands to the cloud server;
the cloud server receiving the lighting control commands and issuing the corresponding first lighting adjustment strategy to the gateway device;
the smart lighting device acquiring the first lighting adjustment strategy forwarded by the gateway device and performing the lighting adjustment of the amusement device based on the first lighting adjustment strategy;
the gateway device uploading the real-time environment data of the amusement device to the cloud server;
the cloud server receiving the real-time environment data, generating a second lighting adjustment strategy matching user habits according to the real-time environment data and a trained lighting adjustment model, and sending the second lighting adjustment strategy to the gateway device, wherein the lighting adjustment model is trained based on the historical environment data and the historical user usage data, and the historical user usage data comprises the offline adjustment data of the smart lighting device uploaded by the gateway device and the remote adjustment data corresponding to historical lighting control commands sent by the user terminal; and
the smart lighting device acquiring the second lighting adjustment strategy forwarded by the gateway device and performing the lighting adjustment of the amusement device based on the second lighting adjustment strategy.

9. The lighting control method for the amusement device according to claim 8, wherein the step of generating a second lighting adjustment strategy matching user habits according to the real-time environment data and a trained lighting adjustment model comprises:
performing a data preprocessing and a feature extraction on the real-time environment data to obtain current time features and current environment features, wherein the data preprocessing comprises data cleaning and data standardization;
inputting the current time features and the current environment features into the lighting adjustment model to obtain a predicted lighting adjustment strategy output by the lighting adjustment model, wherein the lighting adjustment model uses supervised learning algorithms to predict user-preferred lighting settings, unsupervised learning algorithms to identify user usage patterns, and time series analysis to predict user usage times; and
determining the second lighting adjustment strategy based on the predicted lighting adjustment strategy.

10. The lighting control method for the amusement device according to claim 9, wherein the step of determining the second lighting adjustment strategy based on the predicted lighting adjustment strategy comprises:
optimizing the lighting usage time and the lighting brightness in the predicted lighting adjustment strategy based on the preset energy consumption setting parameters to obtain the second lighting adjustment strategy.

11. The lighting control system for the amusement device according to claim 2, wherein the smart lighting device interacts data with the gateway device through a preset communication protocol, and the gateway device is communicatively connected to the cloud server via Wi-Fi or a wired network; and the communication protocol comprises Wi-Fi or Bluetooth.

12. The lighting control system for the amusement device according to claim 3, wherein the smart lighting device interacts data with the gateway device through a preset communication protocol, and the gateway device is communicatively connected to the cloud server via Wi-Fi or a wired network; and the communication protocol comprises Wi-Fi or Bluetooth.

13. The lighting control system for the amusement device according to claim 4, wherein the smart lighting device interacts data with the gateway device through a preset communication protocol, and the gateway device is communicatively connected to the cloud server via Wi-Fi or a wired network; and the communication protocol comprises Wi-Fi or Bluetooth.

14. The lighting control system for the amusement device according to claim 5, wherein the smart lighting device interacts data with the gateway device through a preset communication protocol, and the gateway device is communicatively connected to the cloud server via Wi-Fi or a wired network; and the communication protocol comprises Wi-Fi or Bluetooth.

15. The lighting control system for the amusement device according to claim 6, wherein the smart lighting device interacts data with the gateway device through a preset communication protocol, and the gateway device is communicatively connected to the cloud server via Wi-Fi or a wired network; and the communication protocol comprises Wi-Fi or Bluetooth.
